(19) United States
(12) Patent Application Publication
(10) Pub. No.: US 2026/0115784 A1
(43) Pub. Date: Apr. 30, 2026

(54) FASTENER REMOVAL APPARATUSES AND METHODS OF REMOVING A FASTENER FROM A STRUCTURE

(71) Applicant: HOWMET AEROSPACE INC., Pittsburgh, PA (US)

(72) Inventors: Thomas R. KINGSBURY, Hewitt, TX (US); Troy Don PIERCE, Hewitt, TX (US)

(21) Appl. No.: 19/116,821

(22) PCT Filed: Apr. 4, 2023
(86) PCT No.: PCT/US2023/017453

§ 371 Date: Mar. 28, 2025

Related U.S. Application Data
(60) Provisional application No. 63/481,340, filed on Jan. 24, 2023.

(51) Int. Cl. B21J 15/50; F16B 19/05

(52) U.S. Cl. CPC B21J 15/50; F16B 19/05

(57) ABSTRACT

Fastener removal apparatuses and methods of removing a fastener from a structure are provided. The fastener removal apparatus comprises a cutter and a guide. The cutter comprises a first cutter end, a second cutter end, and an elongated cutter portion extending from the first cutter end to the second cutter end. The elongated cutter portion comprises inner cutter walls defining a cutter cavity. The cutter comprises a cutting portion disposed on the second cutter end and configured to rotate about a longitudinal axis and cut into a fastening collar of a fastener. The guide is disposed in the cutter cavity. The guide is configured to engage the fastening collar and inhibit the cutting portion from moving along the longitudinal axis more than a predetermined distance during cutting of the fastening collar of the fastener.

### FIELD OF USE

The present disclosure relates to fastener removal apparatuses and methods of removing a fastener from a structure.

### BACKGROUND

Vehicle frames, storage racks, solar panel sub-structures, aircraft parts, and other structures can include numerous mechanical fasteners. For example, a fastener (e.g., a bolt, a structural fastener) can be installed in a bore of a structural component and secured by a lockbolt that includes a pin and a fastening collar. Removing a lockbolt presents challenges.

### SUMMARY

One non-limiting aspect of the present disclosure is directed to a fastener removal apparatus comprising a cutter and a guide. The cutter comprises a first cutter end, a second cutter end, and an elongated cutter portion extending from the first cutter end to the second cutter end. A longitudinal axis is defined between the first cutter end and the second cutter end. The elongated cutter portion comprises inner cutter walls defining a cutter cavity. The cutter comprises a cutting portion disposed on the second cutter end and configured to rotate about the longitudinal axis and cut into a fastening collar of a fastener. The guide is disposed in the cutter cavity. The cutter and the guide are configured to move along the longitudinal axis independently of each other. The guide is configured to engage the fastening collar and inhibit the cutting portion from moving along the longitudinal axis more than a predetermined distance during cutting of the fastening collar of the fastener.

Another non-limiting aspect of the present disclosure is directed to a method for removing a fastener from a structure. The method comprises positioning a cutter cavity of a fastener removal apparatus adjacent a fastening collar secured to a pin of a fastener in a bore of a structure. The fastener removal apparatus comprises a cutter and a guide. The cutter comprises a first cutter end, a second cutter end, and an elongated cutter portion extending from the first cutter end to the second cutter end, such that a longitudinal axis is defined between the first cutter end and the second cutter end. The elongated cutter portion comprises inner cutter walls defining a cutter cavity. The cutter further comprises a cutting portion disposed on the second cutter end. The guide is disposed in the cutter cavity. After the positioning, the method comprises forcibly contacting the cutting portion with the fastening collar and rotating the cutting portion, thereby reducing a first diameter of the fastening collar to no greater than a second diameter of the bore. The pin is urged through the bore of the structure, thereby removing the fastener from the structure.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a cross-sectional elevational view of a fastener (e.g., a HUCK® BOBTAIL® fastener, available from Howmet Fastening Systems, Waco, Texas) installed in a bore of a structure;

FIG. 2 is a cross-sectional elevational view of a non-limiting embodiment of a fastener removal apparatus according to the present disclosure shown aligned with the fastener of FIG. 1;

FIG. 3 is a cross-sectional elevational view of the fastener removal apparatus and fastener of FIG. 2 shown after a cutting portion of the fastener removal apparatus has cut a portion of the fastening collar of the fastener;

FIG. 4 is a cross-sectional elevational view of the fastener of FIG. 3 shown after the fastener removal apparatus has been removed from the fastener;

FIG. 5 is a cross-sectional elevational view of the fastener of FIG. 4 shown after a remaining portion of the fastener has been urged through the bore in the structure;

FIG. 6 is a cross-sectional elevational view of a fastener (e.g., a HUCK® BOM® fastener, available from Howmet Fastening Systems, Waco, Texas) installed in a bore of a structure;

FIG. 7 is a cross-sectional elevational view of a non-limiting embodiment of a fastener removal apparatus according to the present disclosure shown aligned with the fastener of FIG. 6;

FIG. 8 is a cross-sectional elevational view of the fastener removal apparatus and fastener of FIG. 7 after a cutting portion of the fastener removal apparatus has cut a portion of the fastening collar of the fastener;

FIG. 9 is a cross-sectional elevational view of the fastener of FIG. 8 shown after the fastener removal apparatus has been removed from the fastener;

FIG. 10 is a cross-sectional elevational view of the fastener of FIG. 9 shown after a portion of the fastener has been urged through the bore in the structure;

FIG. 11 is a cross-sectional elevational view of a fastener (e.g., a HUCK® BOMTAIL® fastener, available from Howmet Fastening Systems, Waco, Texas) installed in a bore of a structure;

FIG. 12 is a cross-sectional elevational view of a non-limiting embodiment of a fastener removal apparatus according to the present disclosure shown aligned with the fastener of FIG. 11;

FIG. 13 is a cross-sectional elevational view of the fastener removal apparatus and fastener of FIG. 12 shown after a cutting portion of the fastener removal apparatus has cut a portion of the fastening collar of the fastener;

FIG. 14 is a cross-sectional elevational view of the fastener of FIG. 13 shown after the fastener removal apparatus has been removed from the fastener;

FIG. 15 is a cross-sectional elevational view of the fastener of FIG. 14 shown after a portion of the fastener has been urged through the bore in the structure;

FIG. 16 is a perspective view of a non-limiting embodiment of a cutter according to the present disclosure;

FIG. 17 is a cross-sectional view of a non-limiting embodiment of a fastener removal apparatus according to the present disclosure;

FIG. 18A is a detail view of area 18A of the fastener removal apparatus of FIG. 17;

FIG. 18B is a detail view of a non-limiting embodiment of a cutting portion of a fastener removal apparatus;

FIG. 19 is a detail view of area 19 of the fastener removal apparatus and fastener of FIG. 3 shown after a cutting portion of the fastener removal apparatus has entered the bore of the structure; and

FIG. 20 is a cross-sectional view of a non-limiting embodiment of a fastener removal apparatus according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed apparatus and methods. The various examples described and illustrated herein are non-limiting and non-exhaustive. Thus, an invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

Removing a fastener from a structure can be difficult and time consuming. For example, removing HUCK® BOM® fasteners, HUCK® BOMTAIL® fasteners, and HUCK® BOBTAIL® fasteners can require cutting the fastening collar with a conventional lockbolt style cutting apparatus and spreading the fastening collar of the lockbolt open far enough to disengage lock grooves on the pin of the lockbolt for removal of the pin. In various non-limiting embodiments, the pin may be hardened, which can dull conventional cutting tools. In certain non-limiting embodiments, once the pin has been removed, it may be necessary to drill out remaining portions of the fastening collar. Some traditional lockbolt cutters are specialized tools that may be bulky and difficult to operate, require specialized equipment, and may be expensive and/or hard to obtain. Traditional lockbolt cutting operations may also be prone to operator error.

The present disclosure provides an improved fastener removal apparatus that can be more efficient to operate, can be smaller than conventional removal tools, and/or can be operated with a drill as opposed to requiring specialized equipment. The present disclosure also provides methods of efficiently and effectively removing a fastener from a structure.

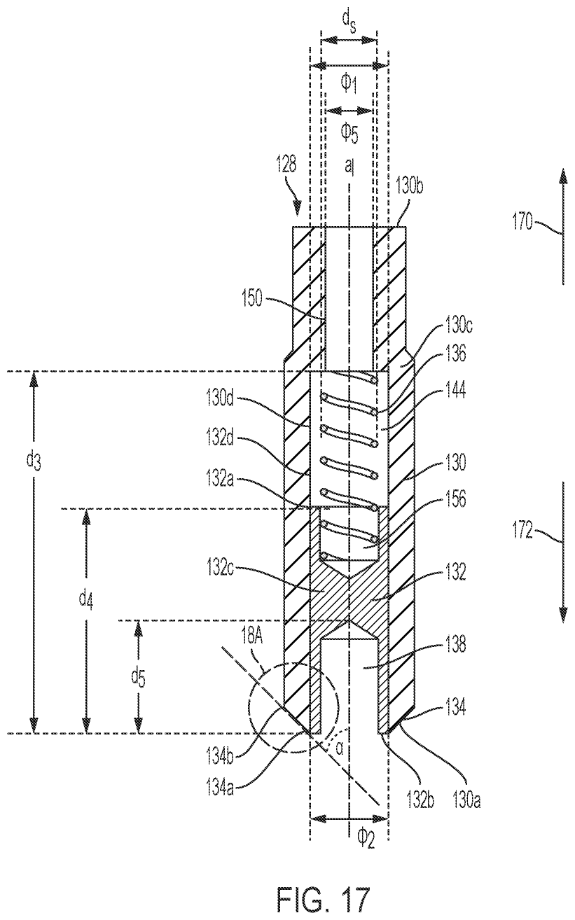

Referring to FIG. 17, a non-limiting embodiment of a fastener removal apparatus 128 according to the present disclosure is provided. The fastener removal apparatus 128 comprises a cutter 130 and a guide 132 configured such that the fastener removal apparatus 128 can deform a fastener such that the fastener can be removed from a structure. The cutter 130 is configured to engage and cut into at least a portion of a fastener. The guide 132 is configured to align the cutter 130 with the fastener and inhibit the cutter 130 from contacting certain surfaces during operation.

Referring to FIG. 17, the cutter 130 can comprise a first cutter end 130a, a second cutter end 130b, and an elongated portion 130c extending from the first cutter end 130a to the second cutter end 130b. A longitudinal axis, a₁, is defined between the first cutter end 130a and the second cutter end 130b. The elongated portion 130c comprises inner walls 130d defining a cutter cavity 144. The second cutter end 130b can be open such that the cutter cavity 144 is configured to receive the guide 132. For example, a diameter, Φ₁, of the cutter cavity 144 can be greater than a diameter, Φ₂, of the guide 132, and the cutter cavity 144 can extend a distance, d₃, into the cutter 130 from the first cutter end 130a, such that the cutter cavity 144 can receive the guide 132. In various non-limiting embodiments, the distance d₃, and diameter, Φ₁, can be suitable to receive a pin of the fastener and/or a fastening collar of a fastener.

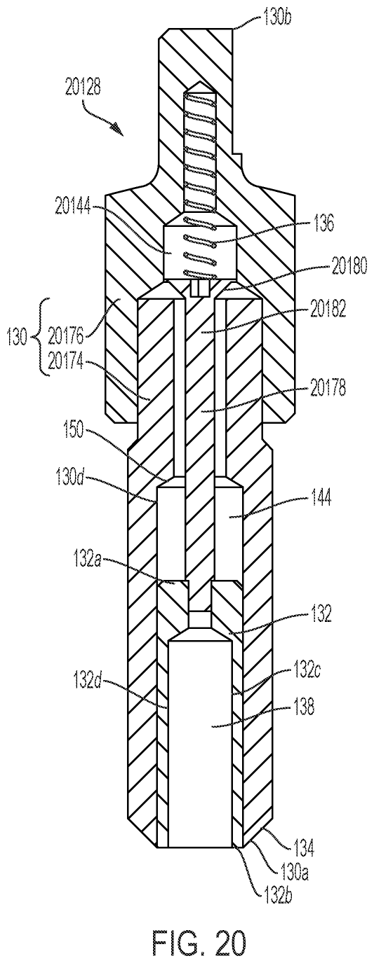

In certain non-limiting embodiments, referring to FIG. 20, the cutter 130 can comprise multiple portions, such as, for example, a first portion 20174 (e.g., cutting portion) and a second portion 20176 (e.g., holding portion). The first portion 20174 can comprise the first cutter end 130a and the cutter walls 130d defining the cutter cavity 144. The second portion 20176 can comprise the second cutter end 130b. The first portion 20174 and the second portion 20176 can be mechanically coupled by, for example, a press fit, a weld, threads, a fastener, and/or an adhesive.

In various non-limiting embodiments, referring again to FIG. 17, the diameter, Φ₁, of the cutter cavity 144 can be at least 0.01 inch, such as, for example, at least 0.25 inches, at least 0.3125 inches, at least 0.375 inches, at least 0.5 inches, at least 0.625 inches, at least 0.75 inches, at least 0.875 inches, or at least 1 inch. In various non-limiting embodiments, the diameter, Φ₁, of the cutter cavity 144 can be no greater than 4 inches, such as, for example, no greater than 1 inch, no greater than 0.875 inches, no greater than 0.75 inches, no greater than 0.625 inches, no greater than 0.5 inches, no greater than 0.375 inches, no greater than 0.3125 inches, or no greater than 0.25 inches. In various non-limiting embodiments, the diameter, Φ₁, of the cutter cavity 144 can be in a range of 0.01 inches to 4 inches, such as, for example, 0.01 inches to 0.5 inches, or 0.01 inches to 1 inch.

In various non-limiting embodiments the distance, d₃, the cutter cavity 144 extends into the cutter 130 can be at least 0.5 inches, such as, for example, at least 1 inch, at least 5 inches, or at least 10 inches. In various non-limiting embodiments, the distance, d₃, the cutter cavity 144 extends into the cutter 130 can be no greater than 20 inches, such as, for example, no greater than 10 inches, no greater than 5 inches, or no greater than 1 inch. In various non-limiting embodiments, the distance, d₃, the cutter cavity 144 extends into the cutter 130 can be in a range of 0.5 inches to 20 inches, such as, for example, 0.5 inches to 2.6 inches, or 0.5 inches to 5 inches.

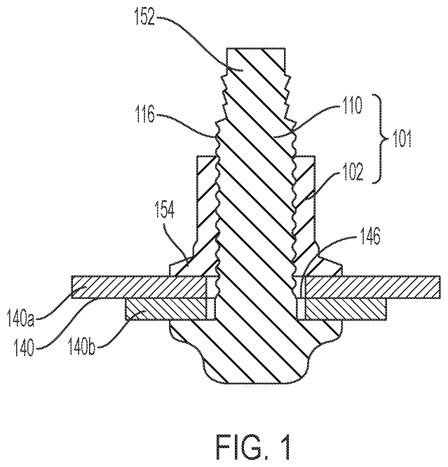

A cutting portion 134 is disposed on the first cutter end 130a. The cutting portion 134 of the cutter 130 is configured to rotate about the longitudinal axis, a₁, and cut into (e.g., machine) a fastening collar of a fastener (e.g., fastening collar 102 of fastener 101 shown in FIG. 1). The rotation of the cutting portion 134 of the cutter 130 can be created by various devices, such as, for example, a drill, a hand crank, a motor, or other device. For example, the second cutter end 130b can be configured to be attached to a drill chuck of a drill, such that the drill can be mechanically attached to the cutter 130 in order to rotate the cutter 130 about the longitudinal axis, a₁, to cut into a fastening collar of a fastener. For example, the second cutter end 130b can be elongated and can be substantially cylindrical and include a knurl, a flat, and/or other feature configured to transfer torque from a drill to the second cutter end 130b.

In further reference to FIG. 17, an angle, a, is defined by a line extending along the cutting portion 134 and intersecting the longitudinal axis, a₁. The angle, α, can be formed at a vertex facing the cutter cavity 144. The angle, a, can be 90 degrees or less, such as, for example, 89 degrees or less, 85 degrees or less, 80 degrees or less, 75 degrees or less, 70 degrees or less, or 50 degrees or less. The angle α, can be at least 5 degrees, such as, for example, at least 10 degrees, at least 20 degrees, or at least 30 degrees. In various non-limiting embodiments, the angle, a, can be in a range of 10 degrees to 90 degrees, such as, for example, 20 degrees to 89 degrees, or 20 degrees to 80 degrees.

In certain non-limiting embodiments, when the angle, a, is 90 degrees or less, the cutter 130 can more efficiently remove chips created during the cutting process by urging the chips away from both a fastener and the cutter cavity 144. The removal of chips during cutting can inhibit chips from jamming within the cutter cavity 144 of the fastener removal apparatus 128 during the cutting process. The angle, α, can enable the efficient removal of a fastener while minimizing damage to a structure in which the fastener is installed.

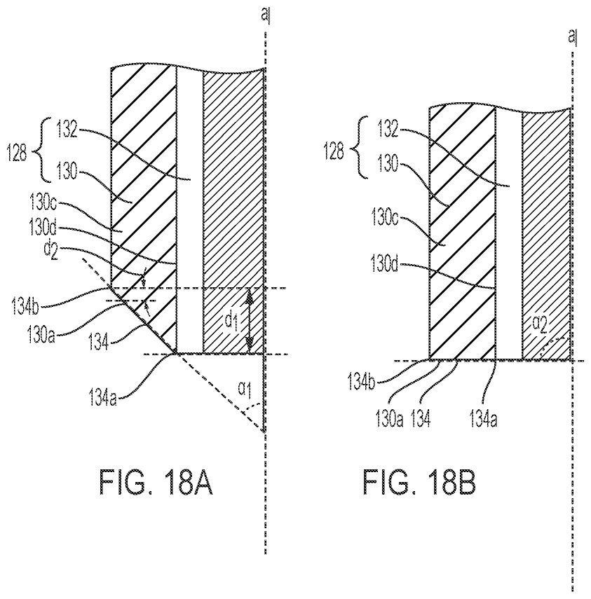

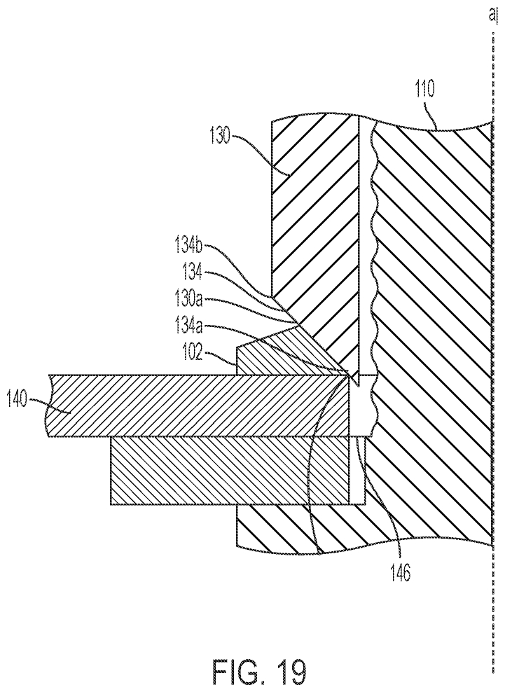

As shown in a non-limiting embodiment of a detail view of the cutting portion 134 in FIG. 18A, the angle, α, can be a reverse angle, α₁. For example, the reverse angle, α₁, can be an acute angle. The angle, α, can enable the efficient removal of a fastener while minimizing damage to a structure in which the fastener is installed. For example, a first region 134a of the cutting portion 134 can extend a distance, d₁, along the elongate portion 130c, which is further than a distance, d₂, by which a second region 134b of the cutting portion 134 extends along the elongate portion 130c. The first region 134a can be more proximal to the guide 132 than the second region 134b, and the first region 134a can be adjacent to the inner walls 130d. The first region 134a can cut completely through a portion of the fastener and pass into a bore in the structure, while the second region 134b may not cut completely through the fastener as discussed below with reference to FIG. 19.

Referring to FIG. 18B, the angle, α, can be substantially 90 degrees, shown as α₂, such that the cutting portion 134 can be flat. For example, the first region 134a of the cutting portion 134 can be substantially aligned with the second region 134b of the cutting portion, such that a line extending along the cutting portion 134 and intersecting the longitudinal axis, a₁, is substantially perpendicular to the longitudinal axis, a₁.

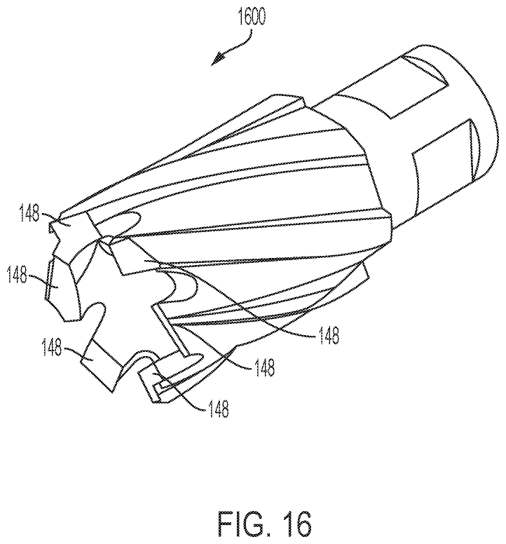

In certain embodiments, the cutter 130 can comprise at least two teeth, such as, for example, at least three teeth, at least four teeth, or at least five teeth. For example, FIG. 16 shows a non-limiting embodiment of a cutter 1600 comprising six teeth 148. The teeth 148 can comprise various shapes, such as, for example, a wedge, a point, a spade, or other shape.

The cutter 130 can comprise various materials. For example, the cutter 130 can comprise a metal, a metal alloy, and/or a ceramic, such as, for example, high-speed steel, cobalt, stainless steel, tungsten carbide, and/or other material.

Referring yet again to FIG. 17, the cutter 130 can be disposed on the exterior surface 132d of the guide 132, and the guide 132 can be disposed in the cutter cavity 144 of the cutter 130. The positioning of the guide 132 within the cutter cavity 144 of the cutter 130 can facilitate removal of chips created during the cutting of the fastening collar 102. The guide 132 can be in a position that may not capture chips during cutting, which can inhibit cutting chip jamming in the fastener removal apparatus 128. Positioning the cutter 130 on the exterior of the guide 132 can enable a more efficient application of a cutting fluid and/or lubricant to the cutting portion 134 of the cutter 130 and/or to a fastener during cutting of a fastening collar.

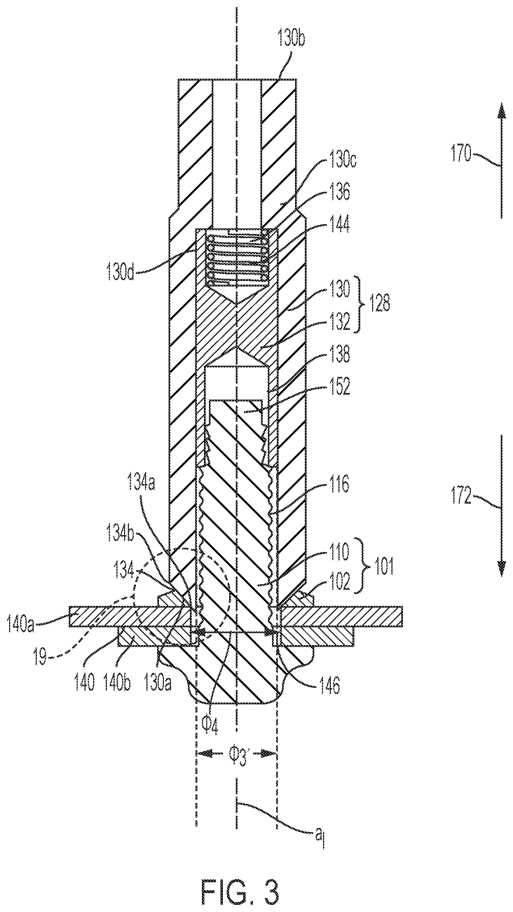

The cutter 130 and the guide 132 can move along the longitudinal axis, a₁, independently of each other. Additionally, in various non-limiting embodiments, the cutter 130 and the guide 132 can rotate about the longitudinal axis, a₁, independently of each other, or the cutter 130 and the guide 132 can rotate about the longitudinal axis, a₁, together. For example, the movement and rotation of the cutter 130 and the guide 132 are described in more detail with reference to FIG. 3 below.

The guide 132 can comprise a first guide end 132a, a second guide end 132b, and an elongated guide portion 132c extending from the first guide end 132a to the second guide end 132b. The guide 132 can comprise a length, d₄, extending from the first guide end 132a to the second guide end 132b.

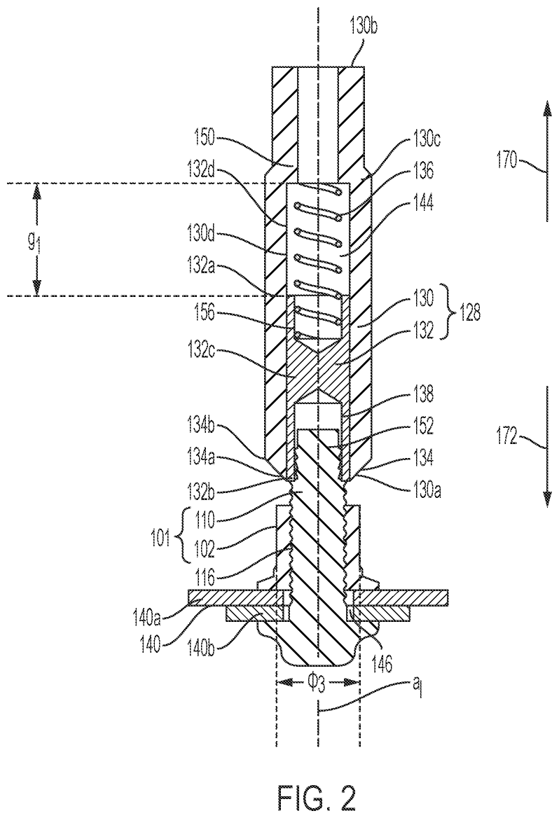

Referring again to FIG. 17, the guide 132 can be configured to inhibit the cutting portion 134 of the cutter 130 from extending beyond a predetermined distance. For example, the inner walls 130d can define a reduced diameter portion 150. The guide 132 can contact the reduced diameter portion 150 after the cutter 130 has moved in a direction 170 to inhibit translation of the cutter 130 relative to the guide 132 beyond the predetermined distance. The predetermined distance can be a distance defined by the distance that the cutter 130 travels from a first position relative to the guide 132, as illustrated in FIG. 2, to a second position relative to the guide 132, as illustrated in FIG. 3. The predetermined distance can substantially inhibit the cutter 130 from contacting a structure 140 in which a fastener 101 is installed and limit the cutter 130 to substantially only contact the fastener 101.

As shown in FIG. 2, when the cutter 130 is in the first position relative to the guide 132, a gap, g₁, is defined between the reduced diameter portion 150 and the first guide end 132a. When the cutter 130 is moved from the first position, as illustrated in FIG. 2, to the second position, as illustrated in FIG. 3, the gap, g₁, between the reduced diameter portion of the cutter cavity 144 and the first guide end 132a can be reduced.

Referring to FIG. 17, the second guide end 132b can be open and can define a guide cavity 138. The guide cavity 138 can extend into the guide 132 a distance, d₅. The distance, d₅, can be suitable to receive at least a portion of a pull section 152 of the fastener 101 and/or a fastening collar 102 of the fastener 101 as illustrated in FIG. 2. The guide cavity 138 can be configured to align the fastener removal apparatus 128 with a fastener 101 by engaging and/or contacting at least a portion of the fastener 101. For example, referring to FIG. 2, the guide cavity 138 can receive the fastening collar 102 of the fastener 101, a pull section 152 of a pin 110 of the fastener 101, or other portion of the fastener 101, such that the guide 132 can engage and/or contact at least a portion of the fastener 101.

Engagement between the guide 132 and the pin 110 can enable enhanced accuracy of removal of the fastening collar 102 and/or improved stability of the fastener removal apparatus 128, which can inhibit damage to the structure 140 during removal of the fastener 101. For example, when the guide 132 engages the fastener 101, the movement of the cutter 130 can be substantially restricted to rotation about the longitudinal axis, a₁, and translation along the longitudinal axis, a₁, while inhibiting the cutter 130 from tilting relative to the fastener 101 and/or otherwise moving in an undesired manner relative to the fastener 101.

Referring back to FIG. 17, the fastener removal apparatus 128 can comprise a spring 136. The spring 136 can be positioned intermediate the guide 132 and the cutter 130 in the cutter cavity 144 such that the spring 136 can urge the cutter 130 into the first position, as shown in FIG. 17. For example, the spring 136 may be intermediate the first guide end 132a and the reduced diameter portion 150 of the cutter 130.

In various non-limiting embodiments, the guide 132 can comprise a spring recess 156 disposed on the first guide end 132a. The spring recess 156 can extend at least partially into the elongated guide portion 132c and can be configured to receive at least a portion of the spring 136 such that the position of the spring can be stabilized.

The spring 136 can comprise a diameter, dₛ, that can be greater than a diameter, Φ₅, of the reduced diameter portion 150 and less than a diameter, Φ₁, of the cutter cavity 144, such that the spring is captured between the guide 132 and the cutter 130. As shown in FIG. 2, when the cutter 130 is in a first position relative to the guide 132, the spring 136 is in an uncompressed state and can maintain the gap, g₁, between the reduced diameter portion 150 and the first guide end 132a. When the cutter 130 has moved from a first position relative to the guide 132 to a second position relative to the guide 132, as shown in FIG. 3, the spring 136 can be compressed.

The spring 136 can be selected based on the amount of force required to move the cutter 130 relative to the guide 132. For example, the compressibility of the spring 136 can be selected to provide a resistive force acting against the cutter 130 while the cutter 130 is moving along the longitudinal axis, a₁, during the cutting process. The compressibility of the spring can be determined based on how much force is required to urge the cutter 130 into the first position, as shown in FIG. 2, such that the guide 132 will contact the fastener 101 prior to and/or simultaneously with the cutter 130 contacting the fastening collar 102.

In various non-limiting embodiments, referring to FIG. 20, the guide 132 can comprise a protrusion 20178, which can be operatively coupled to the guide 132 and configured to engage the spring 136. For example, the protrusion 20178 can be a fastener and the fastener can be threaded into the guide 132. In certain non-limiting embodiments, the protrusion 20178 can comprise a head portion 20180 that extends beyond the first portion 20174 and into a cavity 20144 of the second portion 20176 and the head portion 20180 can be larger in diameter than a shank 20182 of the protrusion 20178. The head portion 20180 can inhibit the guide 132 from extending beyond a predetermined distance by contacting the first portion 20174 and the head portion 20180 may not enter the cavity 144 within the first portion 20174.

In various non-limiting embodiments, the fastener removal apparatus 128 and 20128 can comprise at least one of a metal, a metal alloy, and a composite material. In various non-limiting embodiments, the metal or metal alloy can comprise at least one of aluminum, an aluminum alloy, titanium, a titanium alloy, nickel, a nickel alloy, iron, and an iron alloy (e.g., steel, stainless steel). The composite material can comprise, for example, a carbon fiber composite material.

The fastener removal apparatus 128, 20128 can be manufactured by various processes, such as, for example, at least one of machining, casting, molding, and additive manufacturing. For example, the cutter 130 and guide 132 can be individually machined and then assembled together to form the fastener removal apparatus 128, 20128.

FIGS. 1-5 illustrate a non-limiting embodiment of a method for removing a fastener 101 (e.g., a HUCK® BOBTAIL® fastener) from a structure 140 utilizing an embodiment of the fastener removal apparatus 128 according to the present disclosure. In various non-limiting embodiments, the structure 140 can be configured as an aerospace component or structure, an automotive component or structure, a transportation component or structure, a building and construction component or structure, or other component or structure. In various non-limiting embodiments, the structure 140 can comprise at least two layers, such as, for example, a first layer 140a and a second layer 140b.

As illustrated in FIG. 1, the fastener 101 can comprise a pin 110 and a fastening collar 102 secured to the pin 110. The fastener 101 can be secured to a structure 140 by the fastening collar 102. The fastening collar 102 can be, for example, a bolt collar or nut. The fastening collar 102 can comprise a flange portion 154 which can be integral to the fastening collar 102. The flange portion 154 can comprise a diameter larger than a diameter of the fastening collar 102.

The pin 110 can be located within a bore 146 of the structure 140 and fixed thereto by the fastening collar 102. The pin 110 can comprise a pull section 152. The pin 110 can be, for example, threaded, grooved, and/or substantially smooth. In various non-limiting embodiments in which the pin 110 is grooved, as illustrated in FIGS. 1-5, the fastening collar 102 can be swaged into grooves 116 to secure the fastening collar 102 to the pin 110. In various non-limiting embodiments, the pin 110 of the fastener 101 can have a diameter in a range of 0.06 inches to 4 inches.

As illustrated in FIG. 2, a method for removal of the fastener 101 from the structure 140 can comprise positioning the guide 132 of the fastener removal apparatus 128 adjacent the pin 110 of the fastener 101 in the bore 146 of the structure 140. The guide 132 is in the first position and the gap, g₁, is defined between the reduced diameter portion 150 and the first guide end 132a. In FIG. 2, the guide cavity 138 has received the fastener 101 and has engaged a pull section 152 of the pin 110 of the fastener 101.

After the positioning, referring to FIG. 3, the cutter 130 has been moved towards the fastening collar 102 in direction 172. The cutter 130 of the fastener removal apparatus 128 can move along the longitudinal axis, a₁, independently of the guide 132 between the first configuration shown in FIG. 2 and the second configuration shown in FIG. 3. For example, when the guide cavity 138 has received the fastener 101 and has engaged the fastener 101, the guide 132 can remain substantially in a fixed position relative to the fastener 101 while the cutter 130 is urged towards the structure 140 in direction 172 to cut into the fastening collar 102. By moving the cutter 130 towards the structure 140, the gap, g₁, has been reduced.

After the positioning, and referring again to FIG. 3, the cutting portion 134 has forcibly contacted the fastening collar 102 and cut into the fastening collar 102. The cutting portion 134 can be rotated while in contact with the fastening collar 102 in order to cut into the fastening collar 102. Cutting into the fastening collar 102 reduces a diameter, Φ₃, of the fastening collar 102, as shown in FIG. 2, to a diameter, Φ_{3′}, as shown in FIG. 3, that is no greater than a diameter, Φ₄, of the bore 146. In various non-limiting embodiments, the cutter 130 can be configured to rotate independently from the guide 132, such that when a rotational force is applied to the second cutter end 130b of the cutter 130, the guide 132 remains engaged with the fastener 101 without rotating or rotating at a different speed than the cutter 130. In certain non-limiting embodiments, the cutter 130 and the guide 132 can be configured to rotate substantially together.

Referring to the detailed view in FIG. 19, during cutting of the fastener 101 with a reverse angle, the angle, α₁, of the cutting portion 134 can enable the first region 134a of the cutting portion 134 to enter the bore 146 of the structure 140 while maintaining the second region 134b in a position that is not within the bore 146 or contacting the structure 140. By entering the bore 146, more of the fastening collar 102 can be cut than if the first region 134a did not enter the bore 146.

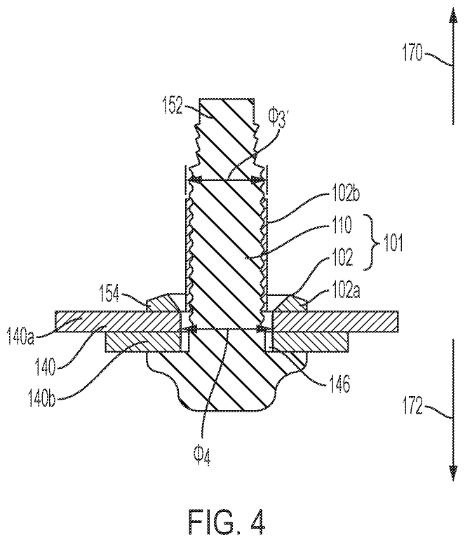

Referring back to FIG. 4, the fastening collar 102 has been cut and the fastener removal apparatus 128 has been retracted and removed from the fastener 101. In various non-limiting embodiments, the fastening collar 102 can be cut into a first portion 102a and a second portion 102b. The first portion 102a can comprise substantially the flange portion 154 and the second portion 102b can comprise portions of the fastening collar 102 that had been swaged into the grooves 116 of the fastener 101.

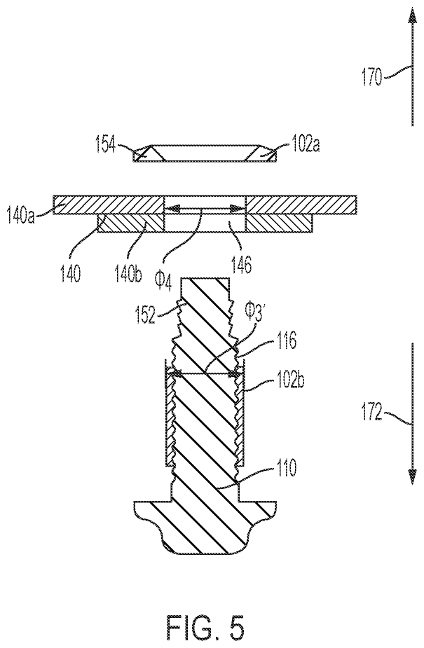

Referring to FIG. 5, the fastener 101 has been removed from the structure. For example, the pin 110 can be urged through the bore 146 of the structure 140 in direction 172 whereas the first portion 102a can be removed in the direction 170. In various non-limiting embodiments, the fastening collar 102 is not removed completely from the grooves 116 of the pin 110 before removing the fastener 101 from the structure 140, which can be advantageous. For example, the second portion 102b of the fastening collar 102 can remain on the pin 110 while the fastener 101 is urged through the bore 146 of the structure 140. In certain non-limiting embodiments, removing the fastener 101 can be a one-step process.

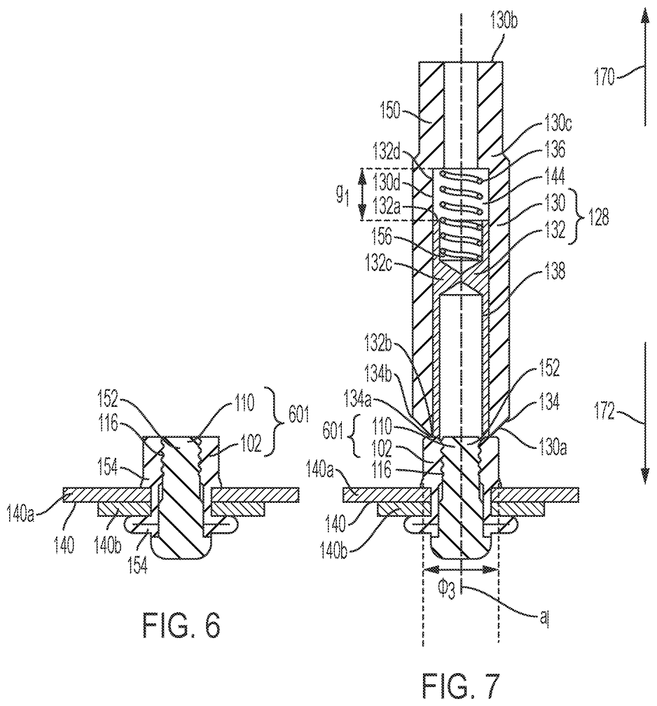

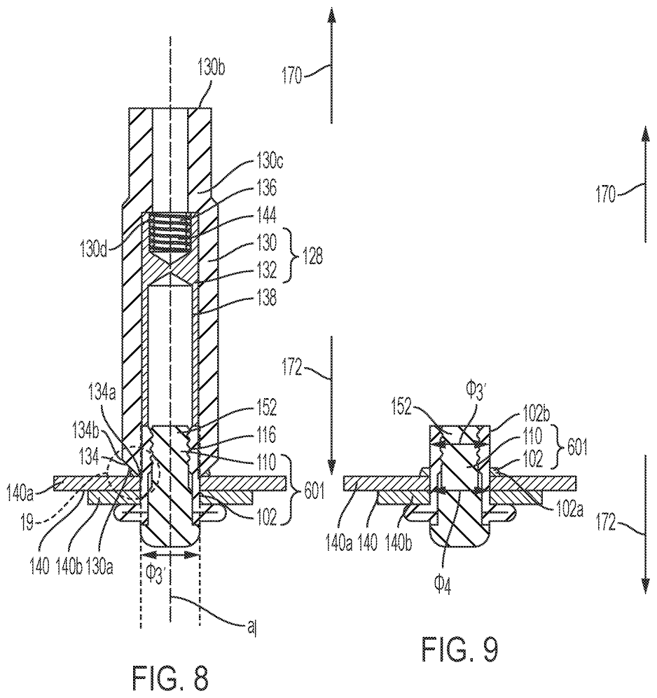

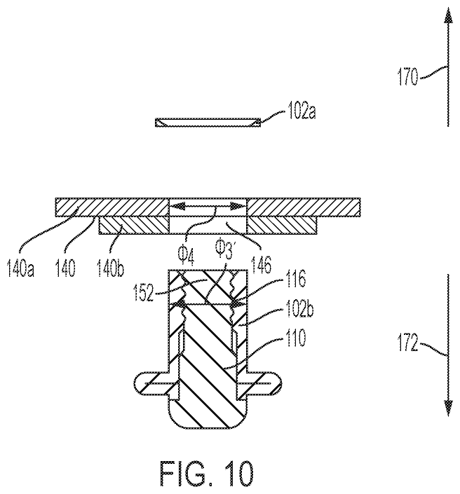

FIGS. 6-10 illustrate a non-limiting embodiment of a method for removal of a fastener 601 (e.g., a HUCK® BOM® fastener) from a structure according to the present disclosure. In various non-limiting embodiments, referring to FIG. 7, the guide 132 can engage the fastening collar 102 of the fastener 601. As shown in FIG. 6, the fastener 601 is a blind fastener and the fastening collar 102 is configured to extend through the bore 146 of the structure 140 and surround the pin 110 of the fastener 601. The method for removal of the fastener 601 can be substantially the same as shown and described with respect to the fastener 101 in FIGS. 1-5 except that the guide 132 may not contact a pull section of the fastener 101 and the guide 132 can contact and engage the fastening collar 102.

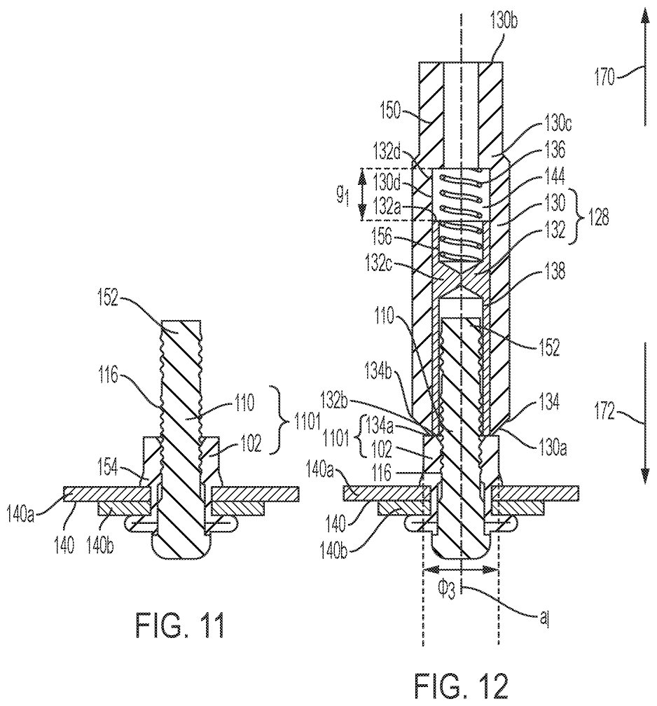

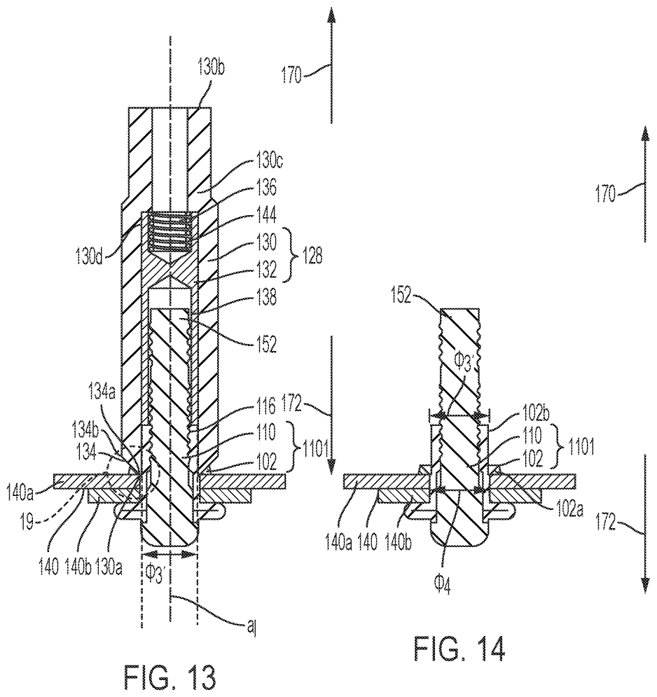

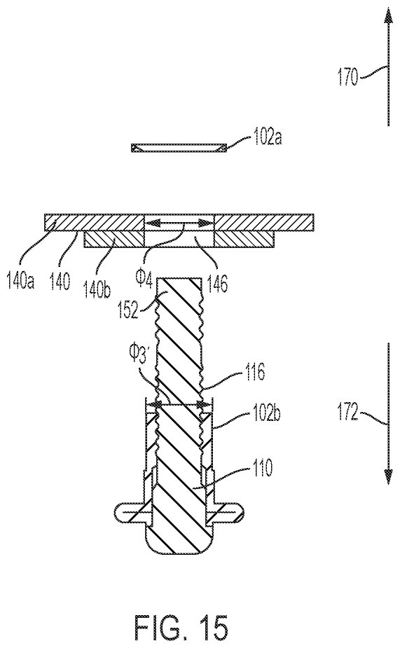

FIGS. 11-15 illustrate a non-limiting embodiment of a method for removal of a fastener 1101 (e.g., HUCK® BOMTAIL® fastener) from a structure 140 according to the present disclosure. In certain non-limiting embodiments, referring to FIG. 12, the guide 132 can engage the pull section 152 and the fastening collar 102 of the fastener 1101. As shown in FIG. 11, the fastener 1101 is a blind fastener, and the fastening collar 102 is configured to extend through the bore 146 of the structure 140. The pin 110 of the fastener 1101 protrudes beyond the fastening collar 102 away from the structure and in the direction 170. The method for removal of the fastener 1101 can be substantially the same as shown and described with respect to the fastener 101 in FIGS. 1-5 except that the guide 132 may engage and contact a pull section 152 and the fastening collar 102 of the fastener 101.

The following numbered clauses are directed to various non-limiting embodiments and aspects according to the present disclosure.

Clause 1. A fastener removal apparatus comprising:
a cutter comprising a first cutter end, a second cutter end, wherein a longitudinal axis is defined between the first cutter end and the second cutter end, an elongated cutter portion extending from the first cutter end to the second cutter end, wherein the elongated cutter portion comprises inner cutter walls defining a cutter cavity, and a cutting portion disposed on the second cutter end and configured to rotate about the longitudinal axis and cut into a fastening collar of a fastener; and
a guide disposed in the cutter cavity, wherein the cutter and the guide are configured to move along the longitudinal axis independently of each other, and wherein the guide is configured to engage the fastening collar and inhibit the cutting portion from moving along the longitudinal axis more than a predetermined distance during cutting of the fastening collar of the fastener.

Clause 2. The fastener removal apparatus of clause 1, wherein the cutter is configured to rotate about the longitudinal axis independently of the guide.

Clause 3. The fastener removal apparatus of any of clauses 1-2, wherein the cutting portion is substantially perpendicular relative to the longitudinal axis.

Clause 4. The fastener removal apparatus of any of clauses 1-2, wherein the cutting portion is at a reverse angle relative to the longitudinal axis.

Clause 5. The fastener removal apparatus of any of clauses 1-4, wherein the cutting portion comprises at least two teeth.

Clause 6. The fastener removal apparatus of any of clauses 1-5, wherein the second cutter end is open, the inner cutter walls comprise a reduced diameter region, and the guide comprises: a first guide end; a second guide end; and an elongated guide portion extending from the first guide end to the second guide end; wherein the first guide end is sized to contact the reduced diameter region to inhibit translation of the cutter along the longitudinal axis relative to the guide to no more than a predetermined distance.

Clause 7. The fastener removal apparatus of clause 6, further comprising a spring intermediate the first guide end and the reduced diameter region.

Clause 8. The fastener removal apparatus of clause 7, wherein the first guide end comprises a spring recess extending at least partially into the elongated guide portion, and the spring recess is configured to receive at least a portion of the spring.

Clause 9. The fastener removal apparatus of any of clauses 6-8, wherein the second guide end defines a guide cavity extending at least partially into the elongated cutter portion, and the guide cavity is configured to receive at least a portion of the fastener.

Clause 10. The fastener removal apparatus of any of clauses 1-9, wherein the first cutter end is configured to be attached to a drill chuck of a drill.

Clause 11. A method for removing a fastener from a structure comprising:
positioning a cutter cavity of a fastener removal apparatus adjacent a fastening collar secured to a pin of a fastener in a bore of a structure, wherein the fastener removal apparatus comprises a cutter comprising a first cutter end, a second cutter end, wherein a longitudinal axis is defined between the first cutter end and the second cutter end, an elongated cutter portion extending from the first cutter end to the second cutter end, wherein the elongated cutter portion comprises inner cutter walls defining a cutter cavity, and a cutting portion disposed on the second cutter end, and a guide disposed in the cutter cavity;
after the positioning, forcibly contacting the cutting portion with the fastening collar and rotating the cutting portion, thereby reducing a first diameter of the fastening collar to no greater than a second diameter of the bore; and
urging the pin through the bore of the structure, thereby removing the fastener from the structure.

Clause 12. The method of claim 11, wherein the cutting portion is rotated by a drill.

Clause 13. The method of any of clauses 11-12, wherein the fastening collar comprises a first collar end; a second collar end; an elongated collar body; and a flange on the second collar end, wherein reducing a first diameter of the fastening collar comprises at least partially removing the flange.

Clause 14. The method of any of clauses 11-13, wherein reducing the first diameter comprises at least partially reducing a diameter of the elongated collar body.

Clause 15. The method of any of clauses 11-14, wherein at least a portion of the fastening collar remains secured to the pin while the pin is urged through the structure.

Clause 16. The method of any of clauses 11-15, wherein forcibly contacting the cutting portion with the fastening collar comprises translating the cutting portion along the longitudinal axis independently of the guide.

Clause 17. The method of clause 16, further comprising inhibiting translation of the cutting portion along the longitudinal axis to no more than a predetermined distance by contacting a reduced diameter region of the inner cutter walls of the cutter with the guide.

Clause 18. The method of any of clauses 11-17, further comprising urging chips produced by cutting the fastening collar away from the cutting portion.

Clause 19. The method of any of clauses 11-18, further comprising aligning a guide cavity of the guide with the pin of the fastener prior to reducing the first diameter of the fastening collar.

Clause 20. The method of any of clauses 11-19, wherein the structure is at least one of an aerospace part or component, an automotive part or component, a transportation part or component, and a building and construction part or component, and wherein a diameter of the pin is in a range of 0.06 inches to 4 inches.

Any references herein to “various embodiments”, “some embodiments”, “one embodiment”, “an embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described fastener removal apparatus, fasteners, structures, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A fastener removal apparatus comprising:
a cutter comprising
a first cutter end,
a second cutter end, wherein a longitudinal axis is defined between the first cutter end and the second cutter end,
an elongated cutter portion extending from the first cutter end to the second cutter end, wherein the elongated cutter portion comprises inner cutter walls defining a cutter cavity, and
a cutting portion disposed on the second cutter end and configured to rotate about the longitudinal axis and cut into a fastening collar of a fastener; and
a guide disposed in the cutter cavity, wherein the cutter and the guide are configured to move along the longitudinal axis independently of each other, wherein the guide is configured to engage the fastening collar and inhibit the cutting portion from moving along the longitudinal axis more than a predetermined distance during cutting of the fastening collar of the fastener.

2. The fastener removal apparatus of claim 1, wherein the cutter is configured to rotate about the longitudinal axis independently of the guide.

3. The fastener removal apparatus of claim 1, wherein the cutting portion is substantially perpendicular relative to the longitudinal axis.

4. The fastener removal apparatus of claim 1, wherein the cutting portion is at a reverse angle relative to the longitudinal axis.

5. The fastener removal apparatus of claim 1, wherein the cutting portion comprises at least two teeth.

6. The fastener removal apparatus of claim 1, wherein the second cutter end is open, the inner cutter walls comprise a reduced diameter region, and the guide comprises:
a first guide end;
a second guide end; and
an elongated guide portion extending from the first guide end to the second guide end;
wherein the first guide end is sized to contact the reduced diameter region to inhibit translation of the cutter along the longitudinal axis relative to the guide to no more than a predetermined distance.

7. The fastener removal apparatus of claim 6, further comprising a spring intermediate the first guide end and the reduced diameter region.

8. The fastener removal apparatus of claim 7, wherein the first guide end comprises a spring recess extending at least partially into the elongated guide portion, and the spring recess is configured to receive at least a portion of the spring.

9. The fastener removal apparatus of claim 6, wherein the second guide end defines a guide cavity extending at least partially into the elongated cutter portion, and the guide cavity is configured to receive at least a portion of the fastener.

10. The fastener removal apparatus of claim 1, wherein the first cutter end is configured to be attached to a drill chuck of a drill.

11. A method for removing a fastener from a structure comprising:
positioning a cutter cavity of a fastener removal apparatus adjacent a fastening collar secured to a pin of a fastener in a bore of a structure, wherein the fastener removal apparatus comprises
a cutter comprising
a first cutter end,
a second cutter end, wherein a longitudinal axis is defined between the first cutter end and the second cutter end,
an elongated cutter portion extending from the first cutter end to the second cutter end, wherein the elongated cutter portion comprises inner cutter walls defining a cutter cavity, and
a cutting portion disposed on the second cutter end; and
a guide disposed in the cutter cavity;
after the positioning, forcibly contacting the cutting portion with the fastening collar and rotating the cutting portion, thereby reducing a first diameter of the fastening collar to no greater than a second diameter of the bore; and
urging the pin through the bore of the structure, thereby removing the fastener from the structure.

12. The method of claim 11, wherein the cutting portion is rotated by a drill.

13. The method of claim 11, wherein the fastening collar comprises
a first collar end;
a second collar end;
an elongated collar body; and
a flange on the second collar end, wherein reducing a first diameter of the fastening collar comprises at least partially removing the flange.

14. The method of claim 13, wherein reducing the first diameter comprises at least partially reducing a diameter of the elongated collar body.

15. The method of claim 11, wherein at least a portion of the fastening collar remains secured to the pin while the pin is urged through the structure.

16. The method of claim 11, wherein forcibly contacting the cutting portion with the fastening collar comprises translating the cutting portion along the longitudinal axis independently of the guide.

17. The method of claim 16, further comprising inhibiting translation of the cutting portion along the longitudinal axis to no more than a predetermined distance by contacting a reduced diameter region of the inner cutter walls of the cutter with the guide.

18. The method of claim 11, further comprising urging chips produced by cutting the fastening collar away from the cutting portion.

19. The method of claim 11, further comprising aligning a guide cavity of the guide with the pin of the fastener prior to reducing the first diameter of the fastening collar.

20. The method of claim 11, wherein the structure is at least one of an aerospace part or component, an automotive part or component, a transportation part or component, and a building and construction part or component, and wherein a diameter of the pin is in a range of 0.06 inches to 4 inches.
